(19) United States
(12) Patent Application Publication
(10) Pub. No.: US 2010/0179723 A1
(43) Pub. Date: Jul. 15, 2010

(54) DRIVER BEHAVIOR BASED REMOTE VEHICLE MIS-USAGE WARNING AND SELF-MAINTENANCE

(75) Inventors: YILU ZHANG, Northville, MI (US); Mark J. Rychlinski, Farmington Hills, MI (US); Nathan D. Ampunan, Novi, MI (US); Yuen-Kwok Chin, Troy, MI (US); Krishnaraj Inbarajan, Troy, MI (US); Paul W. Loewer, South Lyon, MI (US); Mark E. Gilbert, Ann Arbor, MI (US); Shirley B. Dost, Canton, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GENERAL MOTORS CORPORATION@@GM GLOBAL TECHNOLOGY OPERATIONS, INC., Detroit, MI (US)

(21) Appl. No.: 12/353,084

(22) Filed: Jan. 13, 2009

(51) Int. Cl. G01M 17/00

(52) U.S. Cl. 701/35

(57) ABSTRACT

Information associated with vehicle components and sub-systems is monitored by an on-board module, and associated data, either processed or raw, is telematically transmitted to a remote data center by wireless communications. The remote data center archives the received data in a database for each separate vehicle that is part of the system. The remote data center analyzes the data to ascertain whether the data indicates a usage pattern and/or vehicle condition that may have a detrimental effect on certain vehicle components, sub-systems and systems, such as excessive component wear. For example, the data center runs pattern detection algorithms on the data to identify known usage patterns that may potentially impact normal vehicle operation. If such a usage pattern is detected, the remote data center may issue a warning to the vehicle operator, or other designated person, that such usage may have a detrimental effect on the vehicle or vehicle components.

### BACKGROUND OF THE INVENTION

1. Field of the Invention

This invention relates generally to a system and method for detecting vehicle system or component misuse and providing a warning of such misuse and, more particularly, to a system and method for detecting vehicle system or component misuse remotely from the vehicle, and notifying the vehicle operator of the misuse.

2. Discussion of the Related Art

Vehicle components, sub-systems and systems generally have a certain useful life under normal operation after which their failure rate typically significantly increases. However, certain vehicle operations, conditions, situations, etc. may have a detrimental effect on certain vehicle components, sub-systems and systems by reducing their effective life, possibly causing them to fail much earlier than would otherwise be anticipated. For example, excessive auxiliary power usage may drain the vehicle battery, possible preventing the vehicle from being started and possibly damaging the battery as a result of repeated battery drain. Further, repetitive over-capacity towing may accelerate the wear of chassis systems and components, such as brake pads and tires. Also, excessive payload on the vehicle may wear out the vehicle suspension and other related components. Further, a long time non-use of the parking brake may cause brake component corrosion. Also, continually riding the throttle and the brakes of the vehicle at the same time may wear out certain components associated with those systems.

Many times, the various vehicle conditions and operations that result in excessive or abnormal wear of vehicle components, sub-systems and systems are not known by the vehicle operator or owner as they occur, and which may occur gradually over time. Therefore, the vehicle operator may not realize that a component or sub-system could possibly fail as a result of such use until it is too late. Thus, vehicle service and product perception can be enhanced by notifying a vehicle operator or customer of the misuse of various vehicles, sub-systems and components before they have a detrimental effect on those systems and components.

### SUMMARY OF THE INVENTION

In accordance with the teachings of the present invention, information associated with vehicle components and sub-systems is monitored by an on-board module, and associated data, either processed or raw, is telematically transmitted to a remote data center by wireless communications. The remote data center archives the received data in a database for each separate vehicle that is part of the system. The remote data center analyzes the data to ascertain whether the data indicates a usage pattern and/or vehicle condition that may have a detrimental effect on certain vehicle components, sub-systems and systems, such as excessive component wear. For example, the data center may run pattern detection algorithms on the data to identify known usage patterns that may potentially impact normal vehicle operation. If such a usage pattern is detected, the remote data center may issue a warning to the vehicle operator, or other designated person, that such usage may have a detrimental effect on the vehicle or vehicle components.

Additional features of the present invention will become apparent from the following description and appended claims, taken in conjunction with the accompanying drawings.

### BRIEF DESCRIPTION OF THE DRAWINGS

FIG. 1 is an illustration of a system for remotely detecting adverse usage patterns of a vehicle that may potentially impact normal vehicle operation; and

FIG. 2 is a flow chart diagram showing a method for detecting abnormal usage patterns of a vehicle.

### DETAILED DESCRIPTION OF THE EMBODIMENTS

The following discussion of the embodiments of the invention directed to a system and method for detecting abnormal or unhealthy vehicle usage patterns and reporting same to a vehicle customer is merely exemplary in nature, and is in no way intended to limit the invention or its applications or uses.

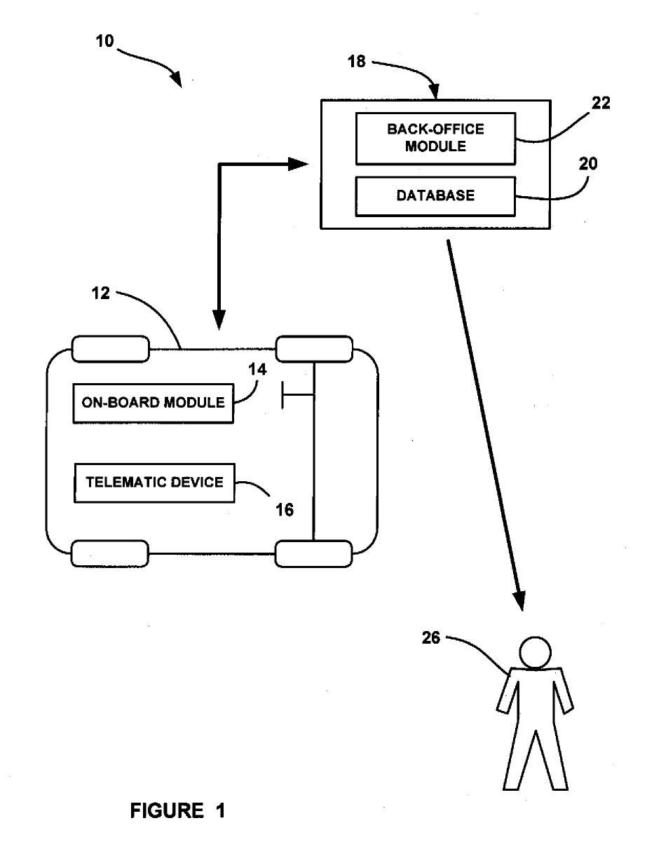

FIG. 1 is an illustration of a vehicle system 10 that collects, stores and processes information relating to the usage of a vehicle 12. The vehicle 12 includes an on-board module 14 that receives data and other information, typically on a vehicle bus, from various vehicle components, sub-systems and systems, and possibly performs certain processing and analysis of the data depending on the computing capacity of the module 14. The on-board module 14 may continuously or intermittently monitor data transferred over in-vehicle communications networks. The on-board module 14 may also request specific data from other on-board modules or electronic control units (ECUs). A telematic transmission device 16 on the vehicle 12 telematically transmits the data from the on-board module 14 through a satellite system, cell phone, or other available wireless communications system. The data can be un-processed raw measurements, such as voltages, or pre-processed information, such as various trouble codes. The telematic device 16 can continuously or intermittently transmit the data. The data transmission can be triggered by time, or an event, such as certain vehicle parameters exceeding a pre-defined threshold.

The system 10 includes a remote data center 18 that telematically receives the information and data transmitted from the vehicle 12. The data center 18 archives the uploaded data in a database 20 for each individual vehicle that may be using or is part of the system 10. The data center 18 includes a back-office module 22 that processes the data received from the vehicle 12, as well as information and data from other vehicles that may be associated with the system 10. The back-office module 22 operates pattern detection algorithms, generally at predetermined intervals, on the received data to identify pre-defined or known usage patterns that may indicate vehicle misuse and potentially impact normal vehicle operation of the vehicle 12.

By identifying certain vehicle activities and operations that may have a detrimental effect on various vehicle components, sub-systems and systems, a vehicle operator, owner or other designated person 26 can be notified of such usage. Such a notification may cause the designated person 26 to change his or her driving habits or vehicle operation habits associated with the vehicle 12 that may reduce wear and tear on the vehicle components, sub-systems and systems. In one embodiment, the designated person 26 is a fleet manager. The data center 18 can contact the designated person 26 in any suitable manner, such as cellular telephone call, e-mail, etc. Further, with the permission of the designated person 26, remote maintenance can be performed, such as recharging the vehicle battery 26 by starting the vehicle 12.

Once the designated person 26 is notified of the adverse usage pattern, then the algorithm can take steps to determine whether the designated person has done anything to correct the problem causing the usage pattern. If the designated person 26 does not take appropriate action, then the algorithm can document the process, possibly invalidating warranties.

The pre-defined usage patterns can be any desirable usage pattern that can be identified based on the information and data that is available. For example, high battery current measured at a power accessory socket during engine off times may indicate an abnormal power drain, such as a laptop connection. This usage may run down the battery and cause a no-start condition. This usage can be detected by periodically uploading battery current measurements. The designated person 26 can be warned to stop such usage with the understanding that it may lead to a no-start condition. With appropriate authorization, the data center 18 may remotely start the vehicle 12 to charge the battery before the battery is fully drained. In another example, constant over-capacity towing can accelerate the wear out of chassis systems and components, such as brake pads and tires. By uploading estimates of load, road grade, etc., this excessive usage can be detected and the designated person 26 can be informed of such existing inappropriate usage. Other examples of improper usage may be a long-time no use of a parking brake, which may cause corrosion, and continuously simultaneously riding on the throttle and brake.

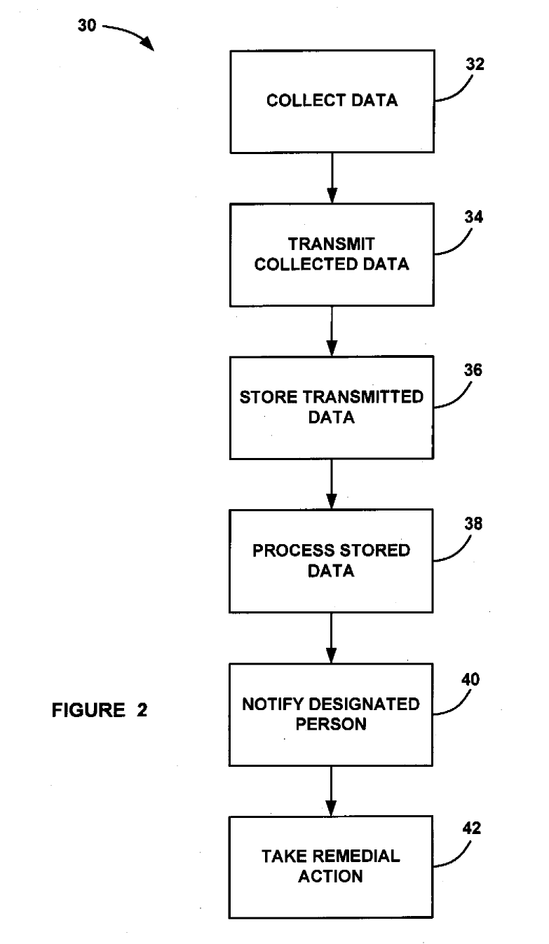

FIG. 2 is a flow chart diagram 30 showing a process for collecting vehicle usage data and identifying improper vehicle usage that may lead to a detrimental effect on vehicle parts and components. The process collects vehicle data at box 32 typically by the on-board module 14. The collected data is then telematically transmitted at box 34 to the remote data center 18. The transmitted data is stored in the database 20 at box 36, and algorithms employed in the back-office module 22 process the data at box 38 to identify usage patterns that are known to have adverse effects on vehicle components. The usage patterns are predetermined and stored in the database 20. If such a usage pattern is detected, then the process notifies the designated person 26 at box 40 to recommend that they change their driving habits to remove the adverse usage pattern. Further, the process can take remedial action at box 42, such as starting the vehicle 12 to recharge the battery.

The foregoing discussion discloses and describes merely exemplary embodiments of the present invention One skilled in the art will readily recognize from such discussion and from the accompanying drawings and claims that various changes, modifications and variations can be made therein without departing from the spirit and scope of the invention as defined in the following claims.

What is claimed is:

1. A method for identifying detrimental vehicle usage patterns and conditions in a vehicle, said method comprising:
collecting vehicle data concerning various vehicle components on the vehicle;
wirelessly transmitting the data collected on the vehicle to a remote data center;
storing the data at the remote data center for a particular vehicle;
analyzing the stored data to identify pre-defined vehicle usage patterns in the data that may have an adverse effect on the vehicle components; and
notifying a designated person of the adverse usage pattern if one is detected.

2. The method according to claim 1 further comprising taking remedial action to remove the adverse usage after notifying the designated person if the designated person authorizes such remedial action.

3. The method according to claim 1 wherein transmitting the data to the remote data center includes transmitting raw data collected on the vehicle.

4. The method according to claim 1 wherein transmitting the data includes transmitting processed data on the vehicle that may include trouble codes.

5. The method according to claim 1 wherein notifying a designated person includes notifying the designated person by cellular telephone or e-mail.

6. The method according to claim 1 wherein notifying the designated person includes notifying a fleet manager.

7. The method according to claim 1 wherein the identified usage pattern is excessive drain on a vehicle battery.

8. The method according to claim 1 wherein the identified vehicle usage pattern is over-capacity towing.

9. The method according to claim 1 wherein the identified vehicle usage pattern is a predetermined time with no use of a vehicle parking brake.

10. The method according to claim 1 wherein the identified usage pattern is continuously and simultaneously riding a vehicle throttle and brake.

11. A method for identifying detrimental vehicle usage patterns and conditions in a vehicle, said method comprising:
collecting vehicle data from a vehicle bus and vehicle modules concerning operation of the vehicle;
wirelessly transmitting the data collected on the vehicle to a remote data center;
storing the data at the remote data center for each vehicle of a plurality of vehicles;
analyzing the stored data to identify pre-defined vehicle usage patterns that may have an adverse effect on vehicle systems and components;
notifying a designation person of the adverse usage pattern if one is detected; and
taking remedial actions to remove the adverse usage pattern after notifying the designated person if the designated person authorized such remedial action.

12. The method according to claim 11 wherein transmitting the data to the remote data center includes transmitting raw data collected on the vehicle.

13. The method according to claim 11 wherein transmitting the data includes transmitting processed data on the vehicle that may include trouble codes.

14. The method according to claim 11 wherein notifying a designated person includes notifying the designated person by cellular telephone or e-mail.

15. The method according to claim 11 wherein notifying the designated person includes notifying a fleet manager.

16. A system for identifying detrimental vehicle usage patterns and conditions in a vehicle, said system comprising:
means for collecting vehicle data concerning various vehicle components on the vehicle;
means for wirelessly transmitting the data collected in the vehicle to a remote data center;
means for storing the data at the remote data center for a particular vehicle;
means for analyzing the stored data to identify pre-defined vehicle usage patterns that may have an adverse effect on the vehicle components; and
means for notifying a designated person of the adverse usage pattern if one is detected.

17. The system according to claim 16 further comprising means for taking remedial action to remove the adverse usage after notifying the designated person if the designated person authorizes such remedial action.

18. The system according to claim 16 wherein the collected data that is transmitted is either or both raw collected data or vehicle information including trouble codes.

19. The system according to claim 16 wherein the means for notifying a designated person includes notifying the designated person by cellular telephone or e-mail.

20. The system according to claim 16 wherein the designated person is a fleet manager.
